(19) United States
(12) Patent Application Publication
(10) Pub. No.: US 2022/0314163 A1
(43) Pub. Date: Oct. 6, 2022

(54) METHOD AND ARRANGEMENT FOR RECOVERING HELIUM

(71) Applicant: Linde GmbH, Pullach (DE)

(72) Inventors: Gabriel SALAZAR DUARTE, München (DE); Martin BAUER, München (DE); Stefan PLEINTINGER, München (DE); Verena KRAMER, München (DE); Matthias JOHANNINK, Köln (DE)

(21) Appl. No.: 17/597,288

(22) PCT Filed: Aug. 6, 2020
(86) PCT No.: PCT/EP2020/025363

§ 371 Date: Dec. 30, 2021

(30) Foreign Application Priority Data
Aug. 20, 2019 (EP) 19020482.6

(51) Int. Cl. B01D 53/22; B01D 53/047; B01D 53/14; C01B 23/00

(52) U.S. Cl. CPC B01D 53/229; B01D 53/226; B01D 53/047; B01D 53/1475; C01B 23/0042; C01B 23/0052; B01D 2256/18; B01D 2257/102; B01D 2257/504; B01D 2257/7025; C01B 2210/0031; C01B 2210/0071; C01B 2210/0051; C01B 2210/0046; C01B 2210/007; C01B 2210/0095

(57) ABSTRACT

A method for recovering helium from a feed gas mixture comprising helium, carbon dioxide and at least one of methane and nitrogen, and wherein at least a part of the feed gas mixture is subjected to a separation sequence including a membrane-based separation and an adsorption-based separation forming a helium product, wherein the the membrane based separation is performed using a first membrane separation step and a second membrane separation step, the membrane based separation and the separation sequence includes no further membrane separation steps, the adsorption based separation is performed using a pressure swing adsorption step, at least a part of the feed gas mixture is subjected to the first membrane separation step forming a first retentate and a first permeate. A corresponding arrangement is also provided.

The present invention relates to a method and to an arrangement for recovering helium from a feed gas mixture, particularly from natural gas, according to the precharacterizing clauses of the independent claims.

### PRIOR ART

Helium is typically recovered from natural gas where it is present at concentrations of up to 1 mole percent. In some cases, the concentrations of helium in natural gas may be even higher. While it is generally also possible to recover helium from atmospheric air by means of cryogenic air separation, this is usually not considered practical due to the low concentrations of helium in air.

Methods for recovering helium from natural gas are e.g. described in the article “Noble Gases” in Ullmann's Encyclopedia of Industrial Chemistry, online edition 15. March 2001, DOI: 10.1002/14356007.a10_045.pub2, and H.-W. Häring (Ed.), Industrial Gases Processing, Wiley-VCH, 2006, particularly chapter 4, “The Noble Gas Helium”. They include cryogenic, membrane-based and combined methods.

Conventionally, helium is recovered from natural gas by cryogenic separation, i.e. by liquefaction of the other components, e.g. during the production of liquefied natural gas or natural gas liquids. In this context, e.g. apparatus including a so-called high-pressure column and a so-called low-pressure column can be used, as particularly shown in FIG. 4.1 in Häring (2006). These columns are operated at cryogenic temperatures at which carbohydrates condense at the operating pressures used, but at which helium still remains in gaseous form.

Helium may also be recovered from natural gas by a combination of membrane-based separation steps and an adsorption step, particularly pressure swing adsorption (PSA) or temperature-based adsorption (TSA). In the membrane-based separation steps, an intermediate mixture enriched in helium is obtained from which components other than helium are removed in the adsorption step. An example for such a method is shown in FIG. 4.2 in Häring (2006). A method for obtaining helium by using a combination of membrane and pressure swing adsorption steps is also disclosed in EP 3 498 668 A1. Such hybrid plants are advantageous if it is not aimed to produce liquified natural gas in a cryogenic system, but only to recover the helium.

The object of the present invention is to provide improved methods of helium recovery from natural gas using a separation sequence comprising membrane based and adsorption-based separation steps.

### DISCLOSURE OF THE PRESENT INVENTION

According to the present invention, a method and an arrangement for recovering helium from natural gas with the features of the independent claims is provided. Advantageous embodiments of the present invention are the subject of the dependent claims and of the description that follows hereinafter.

### Advantages of the Present Invention

The present invention provides an innovative combination of membrane separation and adsorption-based separation steps in a hybrid plant for helium recovery, particularly from natural gas. According to the present invention, furthermore, a carbon dioxide removal step as generally known from the prior art is included in the separation sequence at a specific position which particularly allows for a reduction of the number of membrane separation steps as compared to the prior art. The carbon dioxide removal may e.g. performed using an absorptive (“washing”) step, particularly utilizing a suitable absorbent liquid like an amine solution. For the overall process performance it is advantageous to chose a carbon dioxide removal unit with low helium losses which particularly is a wash unit. The carbon dioxide removal may, however, also be performed using an adsorption step with e.g. an adsorbent selective for carbon dioxide. Also a combination of absorption and adsorption and any way of carbon dioxide removal or depletion is generally possible. The recovery and adjustment of the carbon dioxide content in the remaining gas stream is possible simultaneously.

In summary, aspects of the present invention include that exactly two membrane separation steps or stages (these terms being used synonymously in the following) and an pressure swing adsorption step are used. In this context, a permeate of the first membrane separation step is preferably recompressed and passed to a carbon dioxide removal unit, forming a gas mixture depleted in carbon dioxide, the term “depleted” particularly meaning a reduction of carbon dioxide to a residual content of not more than 5 mol-%, particularly not more than 2 mol-%, particularly to essentially zero.

At least a part of the gas mixture depleted in carbon dioxide is passed to the second membrane separation step. A permeate of the second membrane separation step is preferably recompressed and passed to the pressure swing adsorption step. The retentates of the membrane separation steps can but do not have to be mixed to form a natural gas product depleted in helium, which is recovered in the helium product. The pressure swing adsorption produces a helium rich stream as a helium product and a tail gas with low helium content as an offgas. The tail gas is recycled at a position downstream of the first stage membrane separation and upstream of the second membrane separation step as a recycling steam. A particular advantage of the present invention is that the carbon dioxide removal at the specified position within the separation sequence must not be complete as carbon dioxide will be transferred into the tail gas recycle and thus can be treated in the carbon dioxide removal again. This is also advantageous as compared to an upstream carbon dioxide removal, which would have to be essentially complete to avoid a concentration increase in the recycle over time in case no other carbon dioxide removal option is provided.

The inclusion of the carbon dioxide removal unit directly after the first membrane stage, where “directly” shall be understood to include compression steps as necessary, and optionally a combination with a recycle stream, but no further separation steps, makes the process according to the present invention thus advantageous compared to other methods. The position has advantageous effects which include that carbon dioxide permeates also to the permeate side and consequently dilutes the helium in the permeate. Therefore, the concentration difference of helium between the feed side and the permeate side is increased (the helium concentration raises at the feed side and decreases at the permeate side) and the transport of helium is therefore improved.

Furthermore, the removal of carbon dioxide between the first stage and second stage increases the helium concentration in the feed to the second membrane stage. This enrichment has a positive effect on the helium separation in the second stage. A third membrane stage is therefore dispensible and the required membrane area is decreased. As mentioned, according to the present invention a recycle of the pressure swing adsorption step to a position between the first membrane separation step and the second membrane separation step is formed. When carbon dioxide is removed as proposed according to the present invention, the total flow inside this recycle is much smaller than the total feed flow. The integrated carbon dioxide removal unit will therefore be smaller than an upstream unit.

The process design of this invention stands out due to the fact that both membrane stages are determining for the helium yield, that the tail gas from the pressure swing adsorption step is recycled only upstream of the second membrane separation stage and that the carbon dioxide removal is integrated directly after first membrane stage. In contrast to other methods, e.g. as shown in EP 3 498 668 A1, it was found that the integration of the carbon dioxide removal unit in the permeate of the first stage significantly improves the process performance. In consequence only two membrane stages are necessary to recover the helium and the whole assembly requires smaller membrane areas and provides reduced recycle stream. Therefore, it allows significant economization and savings of resources.

In the language of the claims, the present invention provides a method for recovering helium from a feed gas mixture comprising helium, carbon dioxide and at least one of methane and nitrogen, wherein the feed gas mixture is subjected to a separation sequence including a membrane-based separation and an adsorption-based separation forming a helium product. Options for pretreatment, particularly if natural gas is used in the present invention, are further explained below.

According to the present invention, the membrane-based separation is performed using a first membrane separation step and a second membrane separation step. Further according to the present invention, the membrane-based separation and the separation sequence as a whole includes no further membrane separation steps, i.e. exactly two membrane separation steps are present, according to the invention. The adsorption-based separation is performed using a pressure swing adsorption step.

As to principles and specific embodiments of membrane separation and pressure swing adsorption usable according to the present invention, reference is made to expert literature as well. All methods and devices suitable for separating gas mixtures like the presently used feed gas mixture can be used.

According to the present invention, furthermore, at least a part of the feed gas mixture is subjected to the first membrane separation step forming a first retentate and a first permeate, and at least a part of the first permeate is passed to a carbon dioxide removal step forming a gas mixture depleted in carbon dioxide. At least a part of the gas mixture thus depleted in carbon dioxide is subjected to the second membrane separation step forming a second retentate and a second permeate, at least a part of the second permeate is subjected to the pressure swing adsorption step forming a tail gas and the helium product, and at least a part of the tail gas is recycled at a position between the first membrane based separation step and the second membrane separation step. It may particularly be combined with the first permeate or with the part thereof being subjected to the carbon dioxide removal step. If this is the case, the streams thus combined are subjected to the carbon dioxide removal step without further altering the composition, i.e. they are “directly” fed to the carbon dioxide removal step. However, at least one of temperature, pressure or total amount (i.e. by using only a part) may be changed. Likewise, the gas mixture depleted in carbon dioxide or the part thereof which is subjected to the second membrane separation step is subjected to the second membrane separation without further altering the composition, but optionally including changing least one of temperature, pressure or total amount as above.

The terms “retentate” and “permeate” are used herein as usual in the field of membrane processes. A retentate is obtained as a gas fraction that not passed the membrane used in the membrane process at the end of the contact of a corresponding feed gas mixture to the membrane process. A permeate, in contrast, is obtained as a gas fraction that has passed the membrane. As the size of the helium atom is significantly smaller than all of the other components of natural gas, it preferably passes the membrane and is transferred into the permeate while e.g. methane preferably is retained by the membrane and remains in the retentate.

The term “tail gas” is intended to refer to the gas mixture obtained in the desorption phase of the pressure swing adsorption, that is at the (lower) desorption pressure thereof. In the present invention, an adsorbent is used to which components of natural gas other than helium preferably adsorb. Therefore, the components of a feed gas to the adsorption step which pass the adsorbent in the adsorption step are such components that preferably do not adsorb to the adsorbent. This is mainly helium which is therefore transferred to the helium product.

According to the present invention, the feed gas mixture may be natural gas or may be obtained by submitting natural gas to a pretreatment comprising at least one of a removal of particles, a removal of liquids, a removal of heavy hydrocarbons, a removal of water, a removal of trace components including mercury, sulfur components and/or other trace components. A removal of carbon dioxide is preferably not performed upstream. However, a carbon dioxide content may be reduced in the context of other pretreatment steps as stated, or in a dedicated reduction step, but never below the values as indicated herein. Using such a concentration reduction, instead of a complete removal, can be performed using significantly less complex and costly apparatus.

In the present invention, at least a part of the first retentate and/or of the second retentate may be used in forming a further gas product poor in helium. If natural gas is used as, or in forming the, feed gas mixture, this may be a natural gas product. In other words, these retentates may be combined and used accordingly, or, alternatively, each of the retentates can be used accordingly or may be used otherwise.

According to the present invention, the feed gas mixture comprises carbon dioxide, as mentioned, and the carbon dioxide is particularly present in a content of at least 0.5 mol-%. and up to 60 mol-% This is the case because a pretreatment, if performed does not comprise a removal or at least not a complete removal of carbon dioxide. At least a part of the carbon dioxide is removed in the carbon dioxide removal step which is part of the separation sequence.

Carbon dioxide removal can alternatively also be performed at a different position than that previously mentioned, e.g. before feeding the second permeate or a part thereof to compression and/or to the pressure swing adsorption step, and or in the tail gas which is recycled. It should also be mentioned that the present invention without the carbon dioxide removal step, but besides from that comprising all other features mentioned, can also be used for gas mixtures not comprising carbon dioxide.

According to an embodiment of the present invention, the first permeate or the part thereof being subjected to the carbon dioxide removal step is subjected to a first compression step and/or the gas mixture depleted in carbon dioxide formed in the carbon dioxide removal step being subjected to the second membrane separation step is subjected to a second compression step and/or the second permeate or the part thereof being subjected to the pressure swing adsorption step is subjected to a third compression step. The use of these compression steps and the pressures used therein depend on the pressures at which the retentates are formed and on the pressures required for the subsequent step in the separation sequence.

In a particularly preferred embodiment of the present invention, the tail gas of the pressure swing adsorption step or the part thereof being combined with the first permeate or with the part thereof being subjected to the carbon dioxide removal step may also be subjected to the first compression step after being combined with the first permeate or with the part thereof being subjected to the carbon dioxide removal step. In this way, no separate compression step for a recycle stream formed accordingly is necessary. However, the tail gas or the part thereof being combined with the first permeate or with the part thereof being subjected to the carbon dioxide removal step may also be subjected to a further compression step separate from the first compression step before being combined with the first permeate or with the part thereof being subjected to the carbon dioxide removal step. A compression in the recycle stream may, in this connection, be additionally be performed to the first compression step.

The helium product, as well as a natural gas product, if formed, may be subjected to a compression and/or a liquefaction according to the present invention.

According to the present invention, the feed gas mixture may comprise, besides helium and carbon dioxide, either one of or both nitrogen and methane, wherein either nitrogen or methane may be the bulk component, i.e. making up the major part of the feed gas mixture, at least in the part not being helium and carbon dioxide. The part of the feed gas mixture not being helium and carbon dioxide may thus comprise nitrogen or methane in an amount of at least 50, 60, 70, 80 or 90% by volume, the remainder comprising the other of methane and nitrogen and optionally or alternatively at least one further gas. The part of the feed gas mixture not being helium and carbon dioxide may also essentially consist of nitrogen or methane. Particularly, however, carbon dioxide may be present.

In the method according to the present invention, the feed gas mixture preferably contains 0.1 to 5 mol-% helium. The helium content in the first and second retentate s preferably in the range of 200 ppm or lower and the rest of these retentates essentially consists of the other components of the respective feed mixtures to the membrane stages. From the first to the second permeate via the gas mixture depleted in carbon dioxide, the helium content increases accordingly and the second permeate preferably contains 20 to 40 mol-% helium, which is a concentration particularly suitable to extract such helium in the pressure swing adsorption step. The helium product preferably contains 90 to 99.9999 mol-% helium.

As a feed pressure to the first membrane separation step and to the second membrane separation step e.g 10 to 120 bar, preferably 30 to 80 bar, may be used according to the present invention. A feed pressure to the carbon dioxide removal step may essentially be the same range or lower. A pressure at which the first and second permeates are obtained may e.g. be 0.1 to 7 bar(g), preferably 0.1 to 2 bar(g). An adsorption pressure in the pressure swing adsorption step may e.g. be 5 to 60 bar(g), preferably 5 to 20 bar(g) and a desorption pressure may e.g. be 0.1 to 7 bar(g), preferably 0.1 to 2 bar(g).

An arrangement for recovering helium from natural gas is also part of the present invention. The arrangement comprises means for subjecting at least a part of a feed gas mixture comprising helium and at least one of methane and nitrogen to a separation sequence including a membrane-based separation and an adsorption-based separation forming a helium product. According to the present invention, the membrane-based separation comprises a first membrane separation step and a second membrane separation step, the membrane-based separation and the separation sequence comprise no further membrane separation steps, and the adsorption-based separation comprises a pressure swing adsorption step. According to the invention, means are provided which are adapted to subject at least a part of the feed gas mixture to the first membrane separation step and to form a first retentate and a first permeate, means are provided which are adapted to subject at least a part of the first permeate to a carbon dioxide removal step forming a gas mixture depleted in carbon dioxide, means are provided which are adapted to subject at least a part of the gas mixture depleted in carbon dioxide to the second membrane separation step and to form a second retentate and a second permeate, means are provided which are adapted to subject at least a part of the second permeate to the pressure swing adsorption step and to form a tail gas and the helium product, and means are provided which are adapted to recycle at least a part of the tail gas at a position between the first membrane separation step and the second membrane separation step.

As to further features and advantages of an inventive arrangement and its possible embodiments, particular reference is made to the description of the method according to the present invention and its embodiments as described before. An arrangement according to the present invention is particularly adapted to perform a corresponding method or an embodiment thereof.

The present invention will further be described with reference to the appended drawing illustrating an embodiment of the present invention.

### BRIEF DESCRIPTION OF THE DRAWING

FIG. 1 illustrates an arrangement according to an embodiment of the invention.

### DETAILED DESCRIPTION OF THE DRAWING

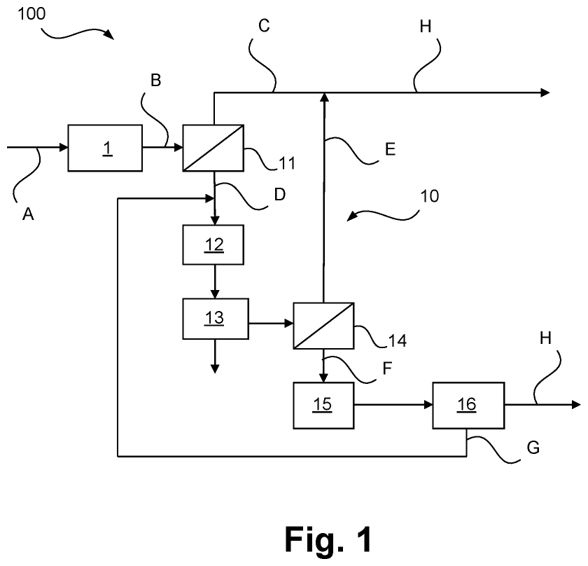

FIG. 1 schematically illustrates an arrangement 100 according to an embodiment of the invention in form of a simplified process diagram. The following explanations likewise relate to a corresponding method.

In the arrangement 100, which is adapted to perform a method according to the present invention, a feed stream A containing helium at least one of methane and nitrogen, e.g. natural gas or a gas mixture formed from natural gas, is subjected to a pretreatment 1 of the kind mentioned before, forming a feed gas mixture B. As mentioned, the pretreatment is entirely optional. At least a part of the feed gas mixture B which also contains helium and at least one of methane and nitrogen is subjected to a separation sequence which is designated 10 in total.

The separation sequence 10 includes a membrane-based separation and an adsorption-based separation, wherein that the membrane-based separation is performed using a first membrane separation step 11 and a second membrane separation step 14. The adsorption-based separation is performed using a pressure swing adsorption step 16. A carbon dioxide removal step 13 is and optionally a first compression step 12 is provided as a part of the separation sequence as well.

In the embodiment shown, at least a part of the feed gas mixture B is subjected to the first membrane separation step 11 forming a first retentate C and a first permeate D. At least a part of the first permeate D is subjected to carbon dioxide removal unit step 13, forming a gas mixture depleted in carbon dioxide (without specific reference numeral). At least a part of the gas mixture depleted in carbon dioxide is subjected to the second membrane separation step 14 forming a second retentate E and a second permeate F. At least a part of the second permeate F is subjected to the pressure swing adsorption step 16 forming a tail gas G and a helium product H.

As also shown, at least a part of the tail gas G is combined with the first permeate D or the part thereof being subjected to the carbon dioxide removal unit step 13. As mentioned, no further membrane-based separation is be performed according to the present invention. As shown, at least a part of the first retentate C and/or of the second retentate E are used in forming a natural gas product K.

As mentioned, in the embodiment shown in FIG. 1, the first permeate D or the part thereof being subjected to the carbon dioxide removal unit step 13 is subjected to a first compression step 12 and/or the second permeate F or the part thereof being subjected to the pressure swing adsorption step 16 is subjected to a compression step 15, previously referred to as “third” separation step. Additionally, the gas mixture depleted in carbon dioxide in the carbon dioxide removal unit step 13 may be compressed (in a “second” compression step). In the embodiment shown, the tail gas G or the part thereof being combined with the first permeate D or with the part thereof being subjected to the carbon dioxide removal unit step 13 is also subjected to the first compression step 12 after being combined with the first permeate D or with the part thereof being subjected to the carbon dioxide removal unit step 13.

The feed gas mixture B, in the embodiment shown, shall comprise carbon dioxide, at least a part of the carbon dioxide being transferred to the first permeate D which is at least in part subjected to a carbon dioxide removal step 13.

1-12. (canceled)

13. A method for recovering helium from a feed gas mixture comprising helium, carbon dioxide and at least one of methane and nitrogen, wherein the feed gas mixture is subjected to a separation sequence including a membrane based separation and an adsorption based separation forming a helium product wherein the membrane based separation is performed using a first membrane separation step and a second membrane separation step, that the membrane based separation and the separation sequence includes no further membrane separation steps, that the adsorption based separation is performed using a pressure swing adsorption step, that at least a part of the feed gas mixture is subjected to the first membrane separation step forming a first retentate and a first permeate, that at least a part of the first permeate is subjected to a carbon dioxide removal step forming a gas mixture depleted in carbon dioxide, that at least a part of the gas mixture depleted in carbon dioxide is subjected to the second membrane separation step forming a second retentate and a second permeate, that at least a part of the second permeate is subjected to the pressure swing adsorption step forming a tail gas and the helium product, and that at least a part of the tail gas is recycled to a position between the first membrane separation step and the second membrane separation step in the separation sequence.

14. The method according to claim 13, wherein the feed gas mixture is obtained by submitting a starting gas mixture to a pretreatment comprising at least one of a removal of particles, a removal of liquids, a removal of heavy hydrocarbons, a removal of water, a removal of trace components including mercury, sulfur components and/or other trace components.

15. The method according to claim 13, wherein the starting gas mixture or the feed gas mixture is natural gas or obtained therefrom.

16. The method according to claim 13, wherein at least a part of the first retentate and/or at least a part of the second retentate are used in forming a further gas product poor in helium.

17. The method according to claim 13, wherein the first permeate or the part thereof being subjected to the carbon dioxide removal step is subjected to a first compression step and/or wherein the gas mixture depleted in carbon dioxide is or the part thereof subjected to the second membrane separation step is subjected to a second compression step and/or wherein the second permeate or the part thereof being subjected to the pressure swing adsorption step is subjected to a third compression step.

18. The method according to claim 17, wherein the tail gas or the part thereof being recycled is combined with the first permeate or with the part thereof being subjected to the carbon dioxide removal step is also subjected to the first compression step after being combined with the first permeate or with the part thereof being subjected to the carbon dioxide removal step.

19. The method according to claim 17, wherein the tail gas or the part thereof being recycled is subjected to a further compression step separate from the first compression step and is thereafter combined with the first permeate or with the part thereof being subjected to the carbon dioxide removal step.

20. The method according to claim 13, wherein the helium product is subjected to a compression and/or a liquefaction.

21. The method according to claim 16, wherein the further gas product is subjected to a compression and/or a liquefaction.

22. The method according to claim 13, wherein the feed gas mixture contains 0.1 to 5 mol-% helium and/or 0.5 to 60 mol-% of carbon dioxide and further comprises, in the part not formed by helium and carbon dioxide, at least 50 mol-% methane and/or nitrogen, wherein the first retentate and the second retentate contain less than 200 ppm helium, wherein the second permeate contains 20 to 40 mol-% helium and wherein the helium product contains 90 to 99.9999 mol-% helium.

23. An arrangement for recovering helium from a feed gas mixture comprising helium and carbon dioxide and at least one of methane and nitrogen, the arrangement comprising means for subjecting at least a part of the feed gas mixture to a separation sequence including a membrane based separation and an adsorption based separation forming a helium product wherein the membrane based separation comprises a first membrane separation step and a second membrane separation step, that the membrane based separation and the separation sequence includes no further membrane separation steps, that the adsorption based separation comprises a pressure swing adsorption step, that means are provided which are adapted to subject at least a part of the feed gas mixture to the first membrane separation step and to form a first retentate and a first permeate, that means are provided which are adapted to subject at least a part of the first permeate to a carbon dioxide removal step forming as gas mixture depleted in carbon dioxide, that means are provided to subject at least a part of the gas mixture depleted in carbon dioxide to the second membrane separation step and to form a second retentate and a second permeate, that means are provided which are adapted to subject at least a part of the second permeate to the pressure swing adsorption step and to form a tail gas and the helium product, and in that means are provided which are adapted to recycle a part of the tail gas at a position between the first membrane separation step and the second membrane separation step in the separation sequence.

24. The arrangement according to claim 11, comprising means adapted to perform a method for recovering helium from a feed gas mixture comprising helium, carbon dioxide and at least one of methane and nitrogen, wherein the feed gas mixture is subjected to a separation sequence including a membrane based separation and an adsorption based separation forming a helium product wherein the membrane based separation is performed using a first membrane separation step and a second membrane separation step, that the membrane based separation and the separation sequence includes no further membrane separation steps, that the adsorption based separation is performed using a pressure swing adsorption step, that at least a part of the feed gas mixture is subjected to the first membrane separation step forming a first retentate and a first permeate, that at least a part of the first permeate is subjected to a carbon dioxide removal step forming a gas mixture depleted in carbon dioxide, that at least a part of the gas mixture depleted in carbon dioxide is subjected to the second membrane separation step forming a second retentate and a second permeate, that at least a part of the second permeate is subjected to the pressure swing adsorption step forming a tail gas and the helium product, and that at least a part of the tail gas is recycled to a position between the first membrane separation step and the second membrane separation step in the separation sequence.
